(19) United States
(12) Patent Application Publication
(10) Pub. No.: US 2008/0171245 A1
(43) Pub. Date: Jul. 17, 2008

(54) HEAT RADIATION PREVENTING FILM, REACTION DEVICE, FUEL CELL DEVICE, ELECTRONIC EQUIPMENT, HEAT REFLECTING FILM, AND HEAT INSULATING CONTAINER

(75) Inventors: Osamu NAKAMURA, Tokyo (JP); Motoki Endo, Tokyo (JP); Tetsushi Ishikawa, Tokyo (JP); Tetsuya Sasakawa, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/013,521

(22) Filed: Jan. 14, 2008

(30) Foreign Application Priority Data
Jan. 15, 2007 (JP) 2007-005414

(51) Int. Cl. H01M 8/06; H01M 8/10; B32B 1/02; B32B 15/00

(52) U.S. Cl. 429/19; 428/457; 428/216; 428/34.1; 429/30

(57) ABSTRACT

Disclosed is a reaction device, including: a reaction device main body; an adhesion layer formed on a surface of the reaction device main body; and a surface layer formed on a surface of the adhesion layer, wherein the adhesion layer includes a material selected from the group consisting of W and Mo, and the surface layer includes Au.

### BACKGROUND OF THE INVENTION

1. Field of the Invention

The present invention relates to a heat radiation preventing film, a reaction device, a fuel cell device, electronic equipment, a heat reflecting film, and a heat insulating container.

2. Description of Related Art

In recent years, a fuel cell using hydrogen as a fuel has been begun to be applied to an automobile, portable equipment, and the like, as a clean power source having high energy conversion efficiency. The fuel cell is a device to take out electric energy from chemical energy directly by allowing a fuel to electrochemically react with oxygen in the air.

As a fuel used for the fuel cell, hydrogen can be cited. The hydrogen has a problem of handing and storing it because it is a gas at an ordinary temperature. If a liquid fuel such as alcohols and gasoline is used, then a vaporizer to vaporize the liquid fuel, a reformer to take out hydrogen necessary for electric power generation by allowing the liquid fuel to react with high temperature steam, a carbon monoxide remover to remove carbon monoxide that is a by-product of a reforming reaction, and the like, become necessary.

Because the operating temperatures of the vaporizer, the carbon monoxide remover, the fuel cell, and the like, are high, it has been performed to house these devices in a heat insulating container to suppress heat radiation. Moreover, it has been also performed to form a heat reflecting film on the inner wall of the heat insulating container to reduce the loss of thermal energy to the outside.

Now, a fuel cell using a solid oxide as the electrolyte thereof is provided with a radiation preventing film on the surface of the fuel cell in order to preventing the radiation from the fuel cell because the operating temperature thereof becomes a temperature within a range from 600° C. to 800° C. Gold (Au) is used as the radiation preventing film and the heat reflecting film in many cases, but Au cannot formed as a film on an insulating materials If the radiation preventing film and the heat reflecting film are formed on the insulating material, for example, titanium (Ti), chromium (Cr), or the like, is accordingly formed as a film on the insulating material as an adhesion layer, and Au is formed as a film on the adhesion layer as a surface layer.

Now, in a fuel cell using a solid oxide as the electrolyte thereof, the operating temperature thereof becomes a temperature within a range from 600° C. to 800° C., and Ti, Cr, and Au mutually diffuse with each other at the temperature within the range from 600° C. to 800° C. Consequently, there is a problem in which the ratio of Au falls, the radiation rate of the fuel cell rises, and the reflectance thereof falls.

### SUMMARY OF THE INVENTION

It is an object of the present invention to prevent the mutual diffusion between the adhesion layer and the surface layer of a heat radiation preventing film or a heat reflecting film at the time of a high temperature.

One aspect of the invention is a heat radiation preventing film, including: an adhesion layer formed on a surface of a heating element; and a surface layer formed on a surface of the adhesion layer, wherein the adhesion layer includes a material selected from the group consisting of W and Mo, and the surface layer includes Au.

One of the other aspects of the invention is a reaction device, including: a reaction device main body; an adhesion layer formed on a surface of the reaction device main body; and a surface layer formed on a surface of the adhesion layer, wherein the adhesion layer includes a material selected from the group consisting of W and Mo, and the surface layer includes Au.

One of the other aspects of the invention is a heat reflecting film, including: an adhesion layer formed on a surface of a housing to house a heating element; and a surface layer formed on a surface of the adhesion layer; wherein the adhesion layer includes a material selected from the group consisting of W and Mo, and the surface layer includes Au.

One of the other aspects of the invention is a heat insulating container, including: a housing to house a heating element; an adhesion layer formed on an inner wall of the housing; and a surface layer formed on a surface of the adhesion layer, wherein the adhesion layer includes a material selected from the group consisting of W and Mo, and the surface layer includes Au.

According to the present invention, it is possible to prevent the mutual diffusion between the adhesion layer and the surface layer of the heat radiation preventing film or the heat reflecting film owing to a high temperature.

### BRIEF DESCRIPTION OF THE DRAWINGS

The present invention will become more fully understood from the following detailed description and the appended drawings, and thus are not intended as a definition of the limits of the invention, and wherein:

FIG. 1 is a block diagram showing electronic equipment 100, to which the present invention is applied;

FIG. 2 is a schematic sectional view showing the internal structure of a reaction device 4;

FIG. 3 is a graph showing relations between the wavelengths and radiation densities of black body radiation at a room temperature, 300° C., 600° C., and 900° C.;

FIG. 4 is a graph showing reflectance of Au, Al, Ag, Cu, and Rh to wavelengths;

FIG. 5 is a schematic sectional view showing the internal structure of a reaction device 7;

FIG. 6 is a graph obtained by plotting anneal temperatures and the rates of changes of sheet resistances;

FIG. 7 is a graph showing the relations between the temperatures and the calculated values of the heat losses of a reaction device main body; and

FIG. 8 is a schematic view showing a modification of the reaction device.

### DETAILED DESCRIPTION OF THE PREFERRED EMBODIMENTS

In the following, the best modes for implementing the present invention will be described with reference to the attached drawings. Incidentally, although technically preferable various limitations for implementing the present invention are given to the embodiments described below, the limitations are not intended to limit the scope of the present invention to the following embodiments and shown examples.

### [Electronic Equipment]

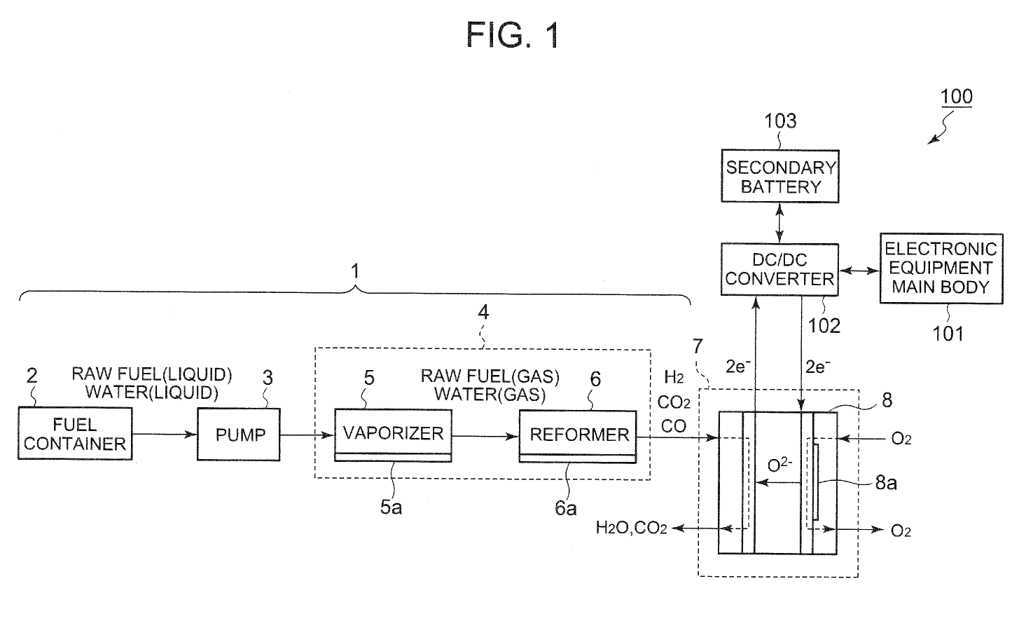

FIG. 1 is a block diagram showing electronic equipment 100, to which the present invention is applied. The electronic equipment 100 is portable type electronic equipment such as a notebook-size personal computer, a personal digital assistant (PDA), an electronic personal organizer, a digital camera, a cellular phone handset, a wrist watch, and game equipment.

The electronic equipment 100 includes a fuel cell device 1, a DC/DC converter 102 to convert the electric energy generated by the fuel cell device 1 into an appropriate voltage, a secondary battery 103 connected to the DC/DC converter 102, an electronic equipment main body 101, to which electric energy is supplied from the DC/DC converter 102.

The fuel cell device 1 generates electric energy as described below, and outputs the generated electric energy to the DC/DC converter 102. The DC/DC converter 102 includes the function of charging the electric energy generated by the fuel cell device 1 into the secondary battery 103 besides the function of converting the electric energy generated by the cell device 1 into an appropriate voltage and supplying the converted voltage to the electronic equipment main body 101 after the conversion. The electronic equipment 100 can thereby supply the electric energy charged in the secondary battery 103 to the electronic equipment main body 101 when the fuel cell device 1 does not operate.

### [Fuel Cell Device]

Next, the fuel cell device 1 is described in detail. The fuel cell device 1 generates electric energy to be output to the DC/DC converter 102, and includes a fuel container 2, a pump 3, a first reaction device 4, a second reaction device 7, and the like. The fuel container 2 of the fuel cell device 1 is provided to be detachably attachable to the electronic equipment 100, and the pump 3 and the reaction devices 4 and 7 are incorporated in the main body of the electronic equipment 100.

The fuel container 2 reserves a mixed liquid of a liquid raw fuel (for example, methanol, ethanol, or dimethyl ether) and water. Incidentally, the liquid raw fuel and the water may be reserved into separate containers.

The pump 3 sucks the mixed liquid in the fuel container 2, and sends the sucked mixed liquid to a vaporizer 5 in a heat insulating container 20.

### [First Reaction Device]

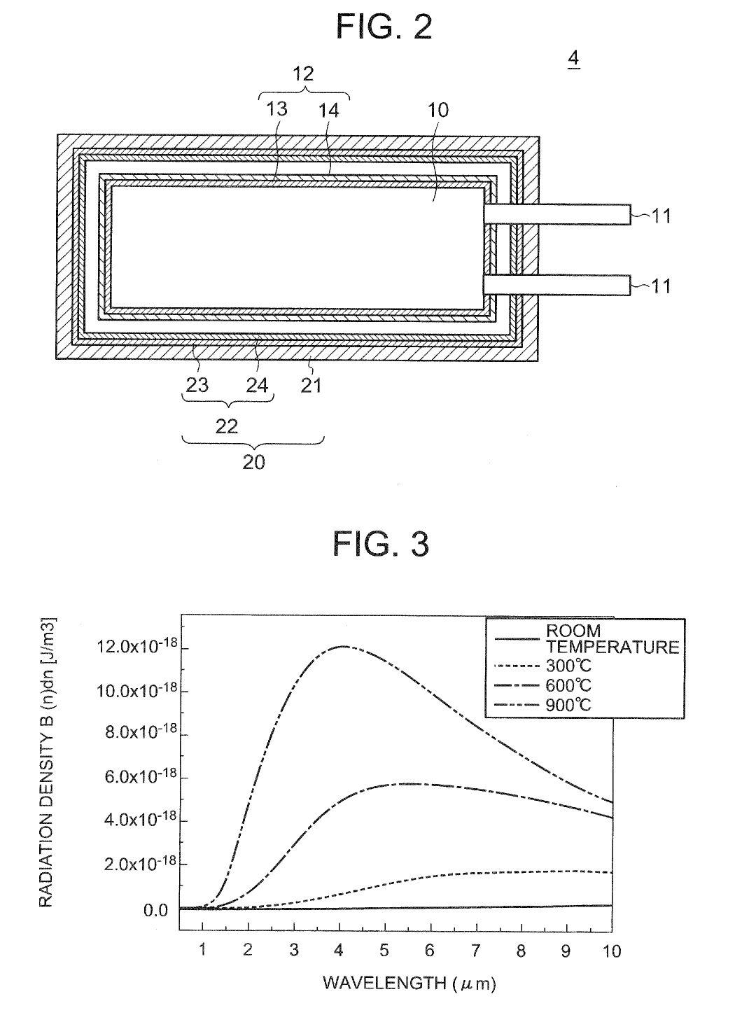

FIG. 2 is a schematic sectional view showing the internal structure of the reaction device 4. The reaction device 4 includes the box-shaped heat insulating container 20 to house a heating element, and a reaction device main body 10 housed in the heat insulating container 20 as the heating element.

### [Heat Insulating Container]

The heat insulating container 20 is composed of a housing 21 and a heat reflecting film 22 formed on the inner wall of the housing 21.

The housing 21 can be formed of a metal plate, such as stainless (SUS 304) and a Kovar alloy, a glass substrate, or the like. The internal space of the heat insulating container 20 is kept to be a low pressure (0.1 Pa or less) in order to prevent heat conduction and a convection owing to gas molecules.

[Heat reflecting film]

The heat reflecting film 22 fulfills the role of reflecting heat rays radiated by the reaction device main body 10, and is composed of an adhesion layer 23 formed on the inner wall of the housing 21 as an underlying layer, and a surface layer 24 formed on the surface of the adhesion layer 23.

The adhesion layer 23 fulfills the role of securing the adhesion property between the housing 21 and the surface layer 24. A material that does not cause any mutual diffusion with the material (described below) to be used for the surface layer 24 at the time of a high temperature operation can be used for the adhesion layer 23, and for example tungsten (W) and molybdenum (Mo) can be used. In the Modification, each purity of tungsten (W) and molybdenum (Mo) is more than 99 mol percent. An alloy including tungsten (W) or molybdenum (Mo) can also be used as a material of the adhesion layer 23. The thickness of the adhesion layer 23 is empirically preferably within a range from about 30 nm to about 50 nm. If the thickness of the adhesion, layer 23 is within the range from about 30 nm to about 50 nm, then the adhesion property can be secured.

The surface layer 24 reflects the heat rays radiated from the reaction device main body 10. The wavelengths radiated from the reaction device main body 10 are examined here.

FIG. 3 is a graph showing the relations between the wavelengths of black body radiation and the radiation densities at a room temperature, 300° C., 600° C., and 900° C. From FIG. 3, the following are known. That is, the radiation densities become high to the wavelengths of 2 μm or longer at 300° C., the wavelengths of 1.24 μm or longer at 600° C., and the wavelengths of 1 μm or longer at 900° C. Consequently, it is required that the surface layer 24 has high reflectances to infrared rays having the wavelengths of 1 μm or longer.

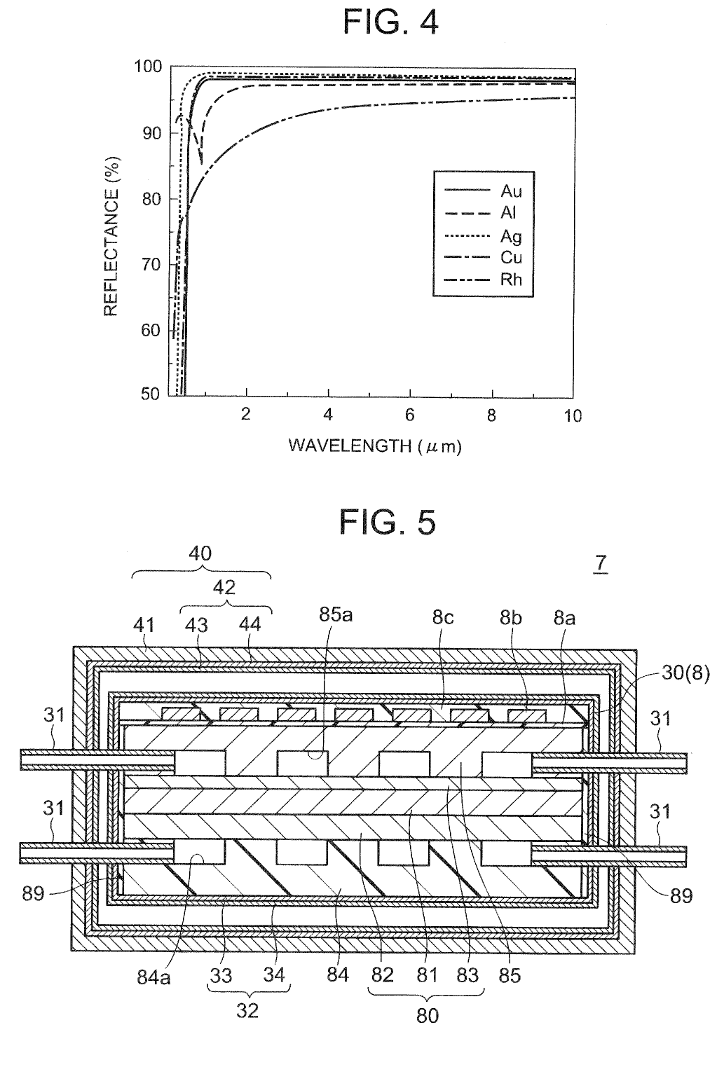

FIG. 4 shows the reflectances of the metals (gold (Au), aluminum (Al), silver (Ag), copper (Cu), and rhodium (Rh)) to be examined as the materials used for the surface layer 24 to wavelengths. Among them, Au and Ag, which have higher reflectances in the wavelength range of 1 μm or longer, can be made to be candidates as the materials of the surface layer 24. Incidentally, it is preferable that purity of gold (Au) is more than 99 mol percent.

However, because Ag evaporates at 600° C., Ag is a metal unsuitable for the use at high temperatures of 600° C. or higher. On the other hand, Au is a metal stable in a temperature range from 600° C. to 800° C., and is suitable for the material of the surface layer 24.

As the thickness of the surface layer 24, it is preferable to be thicker than a thickness at which the intensity of a heat ray that has entered the film becomes about 1/e (skin depth), and it is preferable to be thicker than about 100 nm. If the thickness of the surface layer 24 is thicker than about 100 nm, then the transmission intensity of the heat ray can be made to be 1/e or less, and the reflectance can be made to be (1-1/e) or more.

### [Heat Radiation Preventing Film]

A radiation preventing film 12 is provided on the outer wall surface of the reaction device main body 10. Incidentally, because the reaction device main body 10 is supported by connecting sections 11, which will be described below, the radiation preventing film 12 is disposed to be separated from the heat reflecting film 22.

The radiation preventing film 12 is composed of an adhesion layer 13 to be formed on the outer wall surface of the reaction device main body 10 as an underlying layer, and a surface layer 14 to be formed on the surface of the adhesion layer 13.

The adhesion layer 13 fulfills the role of securing the adhesion property between the reaction device main body 10 and the surface layer 14. The materials that do not cause any mutual diffusion with the materials (described below) to be used for the surface layer 14 at the time of a high temperature operation can be used for the adhesion layer 13, and, for example, W and Mo can be used. The thickness of the adhesion layer 13 is empirically preferably within a range from about 30 nm to about 50 nm. If the thickness of the adhesion layer 13 is within the range from about 30 nm to abut 50 nm, the adhesion property thereof can be secured.

The surface layer 14 fulfills the role of suppressing the radiation of the heat rays from the reaction device main body 10. As shown in FIG. 3, it is known here that the radiation density becomes high to the wavelengths of 2 μm or longer at 300° C., the wavelengths of 1.24 μm or longer at 600° C., and the wavelengths of 1 μm or longer at 900° C. Consequently, the surface layer 14 is required to have low radiation rates to the infrared rays having the wavelengths of 1 μm or longer.

Generally, because (radiation rate)=1−(reflectance), Au and Ag, which have higher reflectances to the wavelengths of 1 μm or longer, as shown in FIG. 4, can be made to be candidates of the materials of the surface layer 14.

However, because Ag evaporates at 600° C., Ag is a metal unsuitable for the use at high temperatures of 600° C. or higher. On the other hand, Au is a metal stable in a temperature range from 600° C. to 800° C., and is suitable for the material of the surface layer 14.

As the thickness of the surface layer 14, it is preferable to be thicker than a thickness at which the transmission intensity of a heat ray that has entered the film becomes about 1/e (skin depth), and it is preferable to be thicker than about 100 nm. If the thickness of the surface layer 14 is thicker than about 100 nm, then the transmission intensity of a heat ray can be made to be 1/e or less, and the reflectance can be made to be (1−1/e) or more.

### [Reaction Device Main Body]

The reaction device main body 10 is supported in the heat insulating container 20 by the connecting sections 11 penetrating the heat insulating container 20, and the reaction device main body 10 is equipped with the vaporizer 5, a reformer 6, and the like, therein. The vaporizer 5 heats the mixed liquid sent from the pump 3 by the heat generated by an electric heater/temperature sensor 5a and the heat transferred from the reformer 6 to a temperature within a range from about 110° C. to about 160° C. to vaporize the mixed liquid. The mixed gas vaporized in the vaporizer 5 is sent to the reformer 6.

A catalyst is carried on the wall surface of the flow path in the reformer 6. The reformer 6 heats the mixed gas sent from the vaporizer 5 to a temperature within a range from about 300° C. to about 400° C. by the heat of an electric heater/temperature sensor 6a to cause a reforming reaction by the catalyst in the flow path. That is, a mixture gas (reformed gas) including hydrogen and carbon dioxide as a fuel, and infinitesimal carbon monoxide and the like as by-products is produced by the catalytic reaction of the raw fuel and water.

Incidentally, if the raw fuel is methanol, then a steam reforming reaction as expressed by the following formula (1) is principally caused in the reformer 6.

CH₃OH+H₂O→3H₂+CO₂ (1)

The carbon monoxide is infinitesimally produced as a by-product in accordance with the following formula (2), which is caused successively to the chemical reaction formula (1).

H₂+CO₂→H₂O+CO (2)

The products (reformed gases) by the reactions of the formulae (1) and (2) are sent out to a fuel cell 8.

Moreover, the electric heater/temperature sensors 5a and 6a are provided to the vaporizer 5 and the reformer 6, respectively. Because the electric resistance values of the electric heater/temperature sensors 5a and 6a depend on temperature, the electric heater/temperature sensors 5a and 6a function as temperature sensors to measure the temperatures of the vaporizer 5 and the reformer 6, respectively.

Incidentally, combustors to heat the vaporizer 5 and the reformer 6, respectively, by the combustion heat generated by burning the reformed gas (offgas) that has passed the fuel cell 8 may be provided in the heat insulating container 20.

### [Second Reaction Device]

FIG. 5 is a schematic sectional view showing the internal structure of the reaction device 7. The reaction device 7 is equipped with a box-shaped heat insulating container 40, and a reaction device main body 30 housed in the heat insulating container 40.

### [Heat Insulating Container]

The heat insulating container 40 is composed of a housing 41 and a heat reflecting film 42 formed on the inner wall of the housing 41.

The housing 41 can be formed of a metal plate, such as stainless (SUS 304) and Kovar alloy, a glass substrate, or the like, similarly to the housing 21. The internal space of the heat insulating container 40 is kept to be a low pressure (0.1 Pa or less) in order to prevent heat conduction and a convection owing to gas molecules

### [Heat Reflecting Film]

The heat reflecting film 42 is composed of an adhesion layer 43 and a surface layer 44 similarly to the heat reflecting film 22.

The adhesion layer 43 fulfills the role of securing the adhesion property between the housing 41 and the surface layer 44. The similar materials to those for the adhesion layer 23 can be used for the adhesion layer 43. The thickness of the adhesion layer 43 is preferably within a range from 30 nm to 50 nm similarly to that of the adhesion layer 23.

The surface layer 44 fulfills the role of reflecting the heat rays radiated from the reaction device main body 30. The similar materials to those to be used for the surface layer 24 can be used for the surface layer 44.

The thickness of the surface layer 44 is preferably a thickness of about 100 nm or more similarly to that of the surface layer 24.

### [Heat Radiation Preventing Film]

A radiation preventing film 32 is provided on the outer wall surface of the reaction device main body 30 with an insulation film 30a formed between them. The insulation film 30a prevents the conduction of the fuel cell 8 in the reaction device main body 30 to the radiation preventing film 32.

The radiation preventing film 32 is composed of an adhesion layer 33 formed on the outer wall surface of the reaction device main body 30 as an underlying layer, and a surface layer 34 formed on the surface of the adhesion layer 33.

The similar materials to those for the adhesion layer 13 can be used for the adhesion layer 33. The thickness of the adhesion layer 33 is preferably within a range from about 30 nm to about 50 nm similarly to that of the adhesion layer 13.

The surface layer 34 fulfills the role of suppressing the radiation of heat rays from the reaction device main body 30. The similar materials as those for the surface layer 14 can be used for the surface layer 34.

The thickness of the surface layer 34 is preferably 100 nm or more similarly to that of the surface layer 14.

### [Reaction Device Main Body]

The reaction device main body 30 is supported in the heat insulating container 40 by connecting sections 31 penetrating the heat insulating container 40, and the reaction device main body 30 is equipped with the fuel cell 8 and the like therein.

The fuel cell 8 is a solid oxide type fuel cell. The fuel cell 8 is equipped with a single cell 80 including a fuel electrode 82 (anode) and an oxygen electrode 283 (cathode), which are severally formed on both the surfaces of a solid oxide electrolyte 81. A fuel electrode separator 84 provided with a fuel feeding flow path 84a to supply a reformed gas to the fuel electrode 82 and a oxygen electrode separator 85 provided with an oxygen feeding flow path 85a to supply oxygen to the oxygen electrode 83 are stacked, and a sealing medium 89 seals the periphery of the fuel cell 8.

An insulation film 8a is formed on the external surface of the fuel cell 8; an electric heater/temperature sensor 8b is formed on the surface of the insulation film 8a; and an insulation film 8c is formed on the surface of the electric heater/temperature sensor 8b. The electric heater/temperature sensor 8b heats the reaction device main body 30 to a temperature within a range from 600° C. to 800° C., which is the operating temperature range of the fuel cell 8.

LaCr(Mg)O₃, (La, Sr)CrO₃, NiAl+Al₂O₃, and the like can be used for the fuel electrode separator 84 and the oxygen electrode separator 85.

Air is sent to the oxygen electrode 83 through the oxygen feeding flow path 85a. At the oxygen electrode 83, oxygen ions are generated by the oxygen in the air and the electrons supplied from a not-shown cathode output electrode as shown in the following formula (3).

O₂+4e⁻→2O²⁻ (3)

Ni, Ni+YSZ, and the like can be used for the oxygen electrode 83.

The solid oxide electrolyte 81 has oxygen ion permeability, and transmits the oxygen ions generated by the oxygen electrode 83 to make the oxygen ions arrive at the fuel electrode 82. Zirconia series (Zr₁₋ₓYₓ)O_{2-x/2}(YSZ), lanthanum gallate series (La₁₋ₓSrₓ) (Ga_{1-y-z}Mg_{y}Co_{z})O₃, and the like, can be used as the solid oxide electrolyte 81.

The reformed gas sent out from the reformer 6 through the fuel feeding flow path 84a is sent to the fuel electrode 82. At the oxygen electrode 83, the reactions shown by the following formulae (4) and (5) of the oxygen ions that have transmitted the solid oxide electrolyte 81 and the reformed gas are caused.

H₂+O²⁻→H₂O+2e⁻ (4)

CO+O²⁻→CO₂+2e⁻ (5)

In this manner, because the operating temperature of the solid oxide type fuel cell is high to be within the range from 600° C. to 800° C., the fuel cell can use CO as a fuel, and can improve the generation efficiency.

Incidentally, the generated electrons are supplied from the cathode output electrode to the oxygen electrode 83 through an external circuit from a not-shown anode output electrode.

La_{0.84}Sr_{0.16}MnO₃, La(Ni, Bi)O₃, (La, Sr)MnO₃, In₂O₃+SnO₂, LaCoO₃, and the like, can be used for the fuel electrode 82.

The reformed gas (offgas) that has passed through the fuel feeding flow path 84a is exhausted to the outside. Incidentally, the combustor to heat the fuel cell 8 by the combustion heat generated by burning the offgas may be provided in the reaction device main body 30.

### [Operation of Fuel Cell Device]

Next, the operation of the fuel cell device 1 is described.

The vaporizer 5, the reformer 6, and the fuel cell 8 are first heated to their operating temperatures by the electric heater/temperature sensors 5a, 6a, and 8b, respectively. Because the vaporizer 5, the reformer 6, and the fuel cell 8 are housed in the heat insulating containers 20 and 40, the heat generated by the electric heater/temperature sensors 5a, 6a, and 8b is efficiently used to heat the vaporizer 5, the reformer 6, and the fuel cell 8, respectively, and can rapidly raise their temperatures to their operating temperatures.

Next, the pump 3 is driven to send out the mixed liquid inside the fuel container 2 to the vaporizer 5. The mixed liquid vaporized by the vaporizer 5 is reformed in the reformer 6, and is sent out to the fuel feeding flow path 84a of the fuel cell 8.

On the other hand, a not-shown air pump is driven to supply air to the oxygen feeding flow path 85a of the fuel cell 8.

Electric power is taken out by the electrochemical reactions of the chemical reaction formulae (3)-(5) by the reformed gas sent out to the fuel cell 8 and air.

### [Examination of Mutual Diffusion]

In the following, the results of the examination of the existence of mutual diffusion in the case where W, Mo, Ti, and Cr were used as the adhesion layer and Au was used as the surface layer are shown in Table 1.

TABLE 1

| SURFACE LAYER/ | |
|---|---|
| ADHESION LAYER | MUTUAL DIFFUSION |
| Au/Ti | EXIST (BELOW 300° C.) |
| Au/Cr | EXIST (BELOW 300° C.) |
| Au/W | NOT EXIST (600° C.) |
| Au/Mo | NOT EXIST (600° C.) |

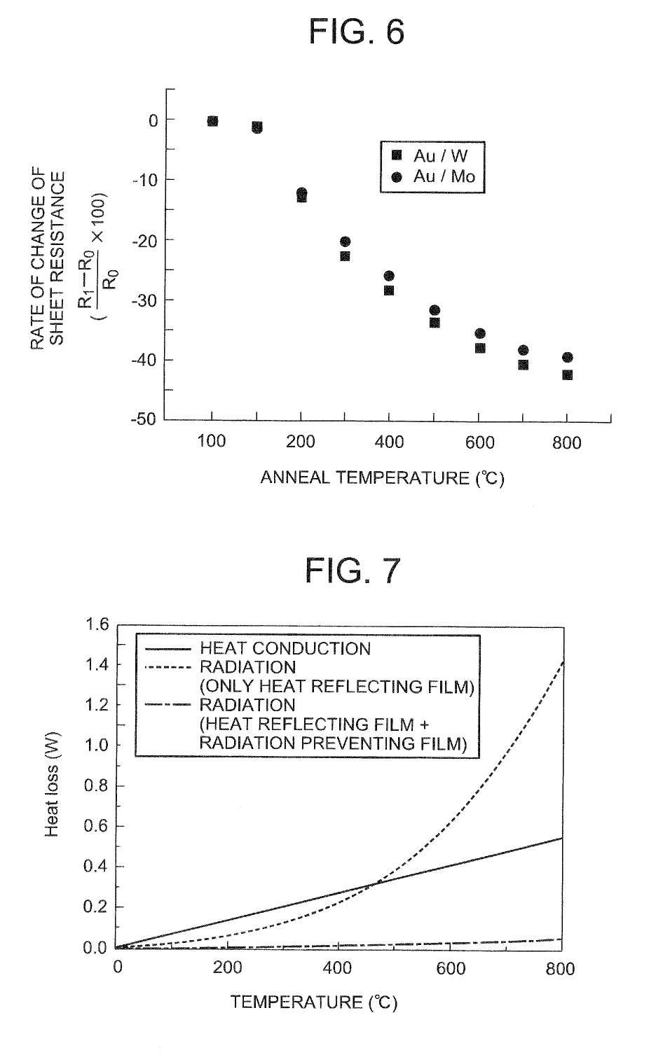

FIG. 6 is a graph produced by plotting anneal temperatures and rates of changes of sheet resistances (=((R₁−R₀)/R₀)×100) in the case where W or Mo was used as the adhesion layer. R₀ is a sheet resistance before heating and R₁ is a sheet resistance after heating here.

Incidentally, the thickness of the surface layer was set to be 200 nm, and the thickness of the adhesion layer was set to be 50 nm.

Because sheet resistance increases when mutual diffusion is caused between the adhesion layer and the surface layer, whether mutual diffusion has been produced or not is judged by whether the sheet resistance has increased or not.

FIG. 6 shows the decrease of resistance, the cause of which seems to be the increase of the size of crystallite, but does not show the increase of resistance. Consequently, it can be considered that no mutual diffusion has been produced.

On the other hand, when Ti or Cr was used as the adhesion layer, the sheet resistance increased at the temperatures less than 300° C., and it can be considered that mutual diffusion was produced.

As mentioned above, by using W or Mo for the adhesion layer and by using Au for the surface layer, a heat reflecting film and a heat radiation preventing film that do not produce any mutual diffusion can be formed. Consequently, even in the reaction device main body 10, the operating temperature of which becomes 300° C. or higher, and even in the reaction device main body 30, the operating temperature of which becomes 600° C. or higher, the rise of the radiation rate can be prevented. Moreover, even in the heat insulating container 20, the temperature of which becomes 300° C. or higher, and even in the heat insulating container 40, the temperature of which becomes 600° C. or higher, the fall of the reflectance can be prevented.

### [Examination of Heat Loss]

Next, the heat loss of a reaction device is examined.

FIG. 7 is a graph showing the relations between the temperatures of a reaction device main body and the calculated values of heat loss. The solid line shows the heat loss owing to the heat conduction of the connecting section; the broken line shows the heat loss owing to the radiation in the case where only the heat reflecting film is provided and no radiation preventing film is provided; and the alternate long and short dash line shows the heat loss of the radiation in the case where both the heat reflecting film and the radiation preventing film are provided.

Incidentally, if the surface area of the reaction device main body was set to be 940 mm², Au was used for the surface layer, and the reflectance of the surface layer was set to be 98%, then the heat loss owing to the radiation in the case where only the heat reflecting film was provided and no radiation preventing film was provided was 0.1 W at 300° C.

The heat loss owing to the heat conduction of the connecting section was supposed to be 0.2 W at 300° C.

In the case where only the heat reflecting film was provided and no radiation preventing film was provided, the heat loss owing to the radiation exceeded the heat loss owing to the heat conduction of the connecting section at 450° C., and the heat insulation in a high-temperature range became insufficient.

On the other hand, the heat loss owing to the case where both of the heat reflecting film and radiation preventing film were provided was 0.03 W or less even in the high-temperature range from 600° C. to 800° C., and it was known that the effect of sufficient heat insulation was able to be obtained also in the high-temperature range.

### <Modification>

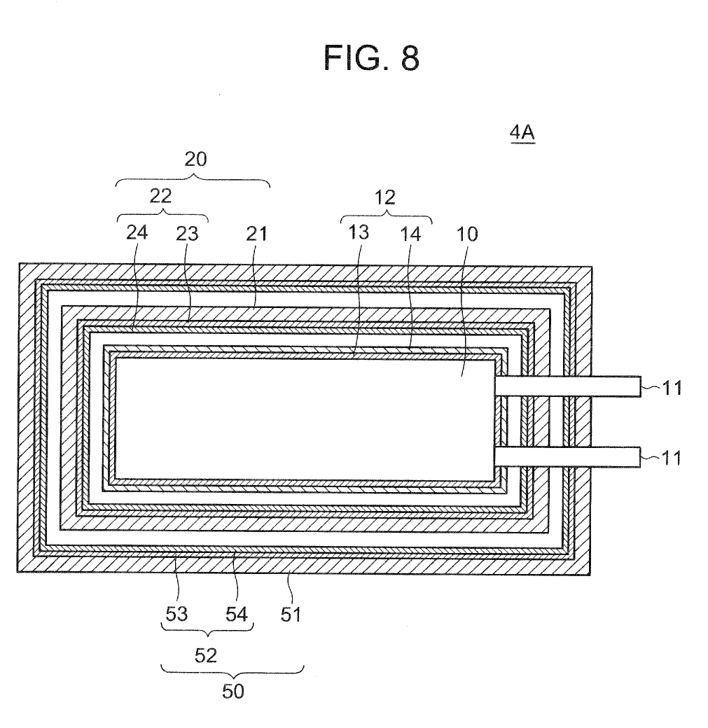

Incidentally, as shown in FIG. 8, the reaction device 4 may modified as a reaction device 4A further equipped with a heat insulating container 50 including a housing 51 separated from the heat insulating container 20 at the outside thereof, and a second heat reflecting film 52, which is composed of an adhesion layer 53 formed on the internal surface of the housing 51 and a surface layer 54 formed on the internal surface of the adhesion layer 53. The similar materials to those of the housing 21 of the heat insulating container 20 can be used for the housing 51, and the similar materials to those of the adhesion layer 23 and the surface layer 24 of the heat reflecting film 22 can be used for the adhesion layer 53 and surface layer 54, respectively, of the heat reflecting film 52. The provision of the second heat reflecting film 52 in addition to the radiation preventing film 12 and the heat reflecting film 22 makes it possible to further improve the heat insulation performance.

In the above embodiments, descriptions have been given to the solid oxide type fuel cell, the operating temperature of which becomes 600° C. or higher, but the fuel cell of the present invention is not limited to that type one. The present invention may be applied to a solid polymer type fuel cell.

Moreover, in the above embodiments, descriptions have been given to the reforming type fuel cell device, but the present invention may be applied to a direct methanol type fuel cell device, which supplies a fuel to a fuel cell directly. That is, a fuel may be directly supplied to the direct methanol type fuel cell.

Incidentally, in the above embodiments, descriptions have been given to the reaction device main body as a heating element, but the present invention can be applied to other heating elements as long as they operate at relatively high temperatures.

All of the disclosures including the patent specification, the claims, the attached drawings and the abstract of Japanese Patent Application No. 2007-005414 filed Jan. 15, 2007 are herein incorporated by reference.

Although various typical embodiments have been shown and described, the present invention is not limited to those embodiments. Consequently, the scope of the present invention can be limited only by the following claims.

What is claimed is:

1. A heat radiation preventing film, comprising:
an adhesion layer formed on a surface of a heating element; and
a surface layer formed on a surface of the adhesion layer, wherein
the adhesion layer includes a material selected from the group consisting of W and Mo, and
the surface layer includes Au.

2. The heat radiation preventing film according to claim 1, wherein
a thickness of the adhesion layer is within a range from 30 nm to 50 nm, and
a thickness of the surface layer is 100 nm or more.

3. The heat radiation preventing film according to claim 1, wherein
the heating element is a reaction device.

4. A reaction device, comprising:
a reaction device main body;
an adhesion layer formed on a surface of the reaction device main body; and
a surface layer formed on a surface of the adhesion layer, wherein
the adhesion layer includes a material selected from the group consisting of W and Mo, and
the surface layer includes Au.

5. The reaction device according to claim 4, wherein
a thickness of the adhesion layer is within a range from 30 nm to 50 nm, and
a thickness of the surface layer is 100 nm or more.

6. The reaction device according to claim 4, further comprising:
a heat reflecting film provided outside the surface layer to be separated from the surface layer.

7. The reaction device according to claim 6, further comprising:
a second heat reflecting film provided outside the heat reflecting film to be separated from the heat reflecting film.

8. The reaction device according to claim 6, wherein
the heat reflecting film includes:
a second adhesion layer formed on an inner wall of a housing to house the reaction device main body; and
a second surface layer formed on a surface of the second adhesion layer, wherein
the second adhesion layer includes a material selected from the group consisting of W and Mo, and
the second surface layer includes Au.

9. The reaction device according to claim 8, wherein
a thickness of the second adhesion layer is within a range from 30 nm to 50 nm, and
a thickness of the second surface layer is 100 nm or more.

10. The reaction device according to claim 4, wherein
the reaction device main body is equipped with a solid oxide fuel cell.

11. The reaction device according to claim 4, wherein
the reaction device main body is equipped with a reformer to produce a gas including hydrogen from a hydrocarbon fuel.

12. A fuel cell device comprising a reaction device according to claim 10.

13. Electronic equipment comprising a fuel cell device according to claim 12.

14. A heat reflecting film, comprising:
an adhesion layer formed on a surface of a housing to house a heating element; and
a surface layer formed on a surface of the adhesion layer; wherein
the adhesion layer includes a material selected from the group consisting of W and Mo, and
the surface layer includes Au.

15. The heat reflecting film according to claim 14, wherein
a thickness of the adhesion layer is within a range from 30 nm to 50 nm, and
a thickness of the surface layer is 100 nm or more.

16. The heat reflecting film according to claim 14, wherein
the heating element is a reaction device.

17. A heat insulating container, comprising:
a housing to house a heating element;
an adhesion layer formed on an inner wall of the housing; and
a surface layer formed on a surface of the adhesion layer, wherein
the adhesion layer includes a material selected from the group consisting of W and Mo, and
the surface layer includes Au.

18. The heat insulating container according to claim 17, wherein
a thickness of the adhesion layer is within a range from 30 nm to 50 nm, and
a thickness of the surface layer is 100 nm or more.

19. The heat insulating container according to claim 17, wherein
the heating element is a reaction device.
